(19) United States
(12) Patent Application Publication
(10) Pub. No.: US 2020/0252849 A1
(43) Pub. Date: Aug. 6, 2020

(54) METHOD, DEVICE FOR SERVICE BEARER NETWORK HANDOVER AND COMPUTER STORAGE MEDIUM

(71) Applicant: GUANGDONG OPPO MOBILE TELECOMMUNICATIONS CORP., LTD., Dongguan (CN)

(72) Inventor: Hai TANG, Dongguan (CN)

(73) Assignee: GUANGDONG OPPO MOBILE TELECOMMUNICATIONS CORP., LTD., Dongguan (CN)

(21) Appl. No.: 16/842,901

(22) Filed: Apr. 8, 2020

Related U.S. Application Data
(63) Continuation of application No. PCT/CN2017/107089, filed on Oct. 20, 2017.

(51) Int. Cl. H04W 36/12; H04W 36/08; H04W 8/24; H04W 48/16; H04W 8/08

(52) U.S. Cl. CPC H04W 36/125; H04W 36/08; H04W 8/08; H04W 48/16; H04W 8/24

(57) ABSTRACT

Embodiments of the disclosure provide a method, a device for a service bearer network handover and a computer storage medium: where the method is applied to a session management function SMF in a 5G network architecture, and the method includes: receiving a request information for establishing a service-specific bearer or a handover indication for the service-specific bearer for a user equipment UE; acquiring service support capability indication information of the UE from pre-obtained service support capability indication information about the UE; and transmitting a system handover request message for the request information or the handover indication based on the service support capability indication information of the UE. Therefore, a complexity of customizing and deploying the UE is reduced, and the network side may determine whether to trigger the fallback to ensure a successful establishment of a service connection.

### CROSS-REFERENCE TO RELATED APPLICATION

This application is a continuation of International Application No. PCT/CN2017/107089, filed on Oct. 20, 2017, the disclosure of which is hereby incorporated by reference in its entirety.

### TECHNICAL FIELD

Embodiments of the present disclosure relates to the field of wireless communication technology, and in particular, to a method, a device for a service bearer to network handover and a computer storage medium.

### BACKGROUND

With the development of communication technology, research on the fifth Generation mobile communication technology (5G, 5^{th} Generation) has also been conducted. The wireless access of 5G is called New Radio, NR for short. 5G has the advantages of ultrahigh data transmission rate, massive numbers of data connection, lower data transmission delay, or the like.

At the initial stage of the construction of the current 5G network, the 5G network can only support a data service, but cannot support a voice service, thereby causing difficulty in deployment of the 5G network.

### SUMMARY

To solve the foregoing technical problem, embodiments of the present disclosure expect to provide a method, a device for a service bearer network handover and a computer storage medium, which can fall back to a communication network with a voice service under a condition where the voice service is not supported in an initial construction stage of a 5G network, thereby preventing a situation where the 5G network is difficult to deploy form happening.

Technical solutions of the embodiments of the present disclosure can be implemented as follows:

In a first aspect, an embodiment of the present disclosure provides a method for a service bearer network handover, which the method is applied to a session management function (SMF) in a 5G network architecture, where the method includes:
receiving a request information for establishing a service-specific bearer or a handover indication for the service-specific bearer for a user equipment (UE); where the handover indication for the service-specific bearer is used to indicate a service of which the service-specific bearer needs a handover from 5G to fourth Generation mobile communication technology (4G, 4^{th} Generation) or second Generation mobile communication technology (2G, 2^{nd} Generation/third Generation mobile communication technology (3G, 3^{rd} Generation), or to indicate a handover of a whole service system from 5G to 4G or 2G/3G;
acquiring service support capability indication information of the UE from pre-obtained service support capability indication information about the UE; and
transmitting a system handover request message for the request information or the handover indication based on the service support capability indication information of the UE.

In a second aspect, an embodiment of the present disclosure provides a method for a service bearer network handover, which is applied to a core access and mobility management function (AMF) in a 5G network architecture, where the method includes:
receiving service support capability indication information of a UE transmitted by the UE and/or an old AMF in a registration procedure of the UE; or receiving the service support capability indication information of the UE transmitted by the UE in a session establishment procedure for the UE; and
transmitting the service support capability indication information of the UE to a session management function (SMF); where the service support capability indication information of the UE is used for the SMF to perform a system handover when a service-specific bearer is established for the UE.

In a third aspect, an embodiment of the present disclosure provides a method for a service bearer network handover, which is applied to a mobility management entity (MME) in a 4G network architecture, where the method includes:
receiving service support capability indication information of a user equipment (UE) transmitted by a core access and mobility management function (AMF) in a 5G network architecture; and
executing a circuit switched fallback (CSFB) procedure when the service support capability indication information of the UE is indication information used to indicate that the UE needs a voice service and only supports a circuit switched service.

In a fourth aspect, an embodiment of the present disclosure provides a network apparatus, including; a first receiving part, an acquiring part and a first transmitting part: where
the first receiving part is configured to receive a request information for establishing a service-specific bearer or a handover indication for the service-specific bearer for a user equipment (UE); where the handover indication for the service-specific bearer is used to indicate a service of which the service-specific bearer needs a handover from 5G to 4G or 2G/3G, or to indicate a handover of a whole service system from 5G to 4G or 2G/3G;
the acquiring pun is configured to acquire service support capability indication information of the UE from pre-obtained service support capability indication information about the UE; and
the first transmitting part is configured to transmit a system handover request message for the request information or the handover indication based on the service support capability indication information of the UE.

In a fifth aspect, an embodiment of the present disclosure provides a network apparatus, including; a second receiving part and a second transmitting part; where
the second receiving part is configured to receive service support capability indication information of a UE transmitted by the UE and or an old AMF in a registration procedure of the UE; or receive the service support capability indication information of the UE transmitted by the UE in a session establishment procedure for the UE; and
the second transmitting part is configured to transmit the service support capability indication information of the UE to a session management function (SMF); where the service support capability indication information of the UE is used for the SMF to perform a system handover when a service-specific bearer is established for the UE.

In a sixth aspect, an embodiment of the present disclosure provides a network apparatus, including: a third receiving part and an executing part; where
the third receiving part is configured to receive service support capability indication information of a user equipment UE transmitted by a core access and mobility management function (AMF) in a 5G network architecture; and
the execution part is configured to execute a circuit switched fallback (CSFB) procedure when the service support capability indication information of the UE is indication information used to indicate that the UE needs a voice service and only supports a circuit switched service.

In a seventh aspect, an embodiment of the present disclosure provides a network apparatus, including: a first network interface, a first memory and a first processor: where
the first network interface is configured to receive and transmit a signal in a process of receiving and transmitting information with other external network elements:
the first memory is configured to store a computer program capable of running on the first processor; and
the first processor, when running the computer program, is configured to execute the steps of the method according to the first aspect.

In an eighth aspect, an embodiment of the present disclosure provides a network apparatus, including: a second network interface, a second memory and a second processor, where
the second network interface is configured to receive and transmit a signal in a process of receiving and transmitting information with other external network elements;
the second memory is configured to store a computer program capable of running on the second processor; and
the second processor, when running the computer program, is configured to execute the steps of the method according to the second aspect.

In a ninth aspect, an embodiment of the present disclosure provides a network apparatus, including: a third network interface, a third memory and a third processor; where
the third network interface is configured to receive and transmit a signal in a process of receiving and transmitting information with other external network elements;
the third memory is configured to store a computer program capable of running on the third processor; and
the third processor, when running the computer program, is configured to execute the steps of the method according to the third aspect.

In a tenth aspect, an embodiment of the present disclosure provides a computer readable medium, stored with a program for a service bearer network handover, where the program for the service bearer network handover implements the steps of the method according to the first aspect or the second aspect or the third aspect when executed by at least one processor.

Embodiments of the present disclosure provide a method, device for a service bearer network handover and a computer storage medium; the SMF may determine, after acquiring the service support capability indication information of the UE in advance, whether a bearer of a voice service falls back from a 5G network to a 4G network or from the 5G network to a 2G or 3G network according to the service support capability indication information of the UE when the UE performs the voice services, thereby determining whether to transmit a first fallback indication information or a second fallback indication information. Therefore, the UE cannot sense a fallback of a service bearer network in the network side, and the UE also does not need to actively judge a initiating mode of the a voice service, thereby reducing a complexity of customizing and deploying the UE, and the network side may determine whether to trigger the fallback to ensure a successful establishment of a service connection according to a service support capability of the UE in combination with a service support capability of the network side itself.

### BRIEF DESCRIPTION OF DRAWINGS

FIG. 1 is a schematic diagram of an atypical 5G network infrastructure;

FIG. 2 is a schematic flowchart of a method for a service bearer network handover provided by an embodiment of the present disclosure;

FIG. 3 is a schematic flowchart of another method for a service bearer network handover provided by an embodiment of the present disclosure;

FIG. 4 is a schematic flowchart of still another method for a service bearer network handover provided by an embodiment of the present disclosure;

FIG. 5 is a schematic flowchart of a way to execute a CSFB procedure provided by an embodiment of the present disclosure;

FIG. 6 is a schematic flowchart of another way to execute a CSFB procedure provided by an embodiment of the present disclosure;

FIG. 7 is a schematic flowchart of a first specific example provided by an embodiment of the present disclosure;

FIG. 8 is a schematic flowchart of a second specific example provided by an embodiment of the present disclosure;

FIG. 9 is a schematic flowchart of a third specific example provided by an embodiment of the present disclosure;

FIG. 10 is a schematic flowchart of a fourth specific example provided by an embodiment of the present disclosure;

FIG. 11 is a schematic flowchart of a network fallback when an MO UE performs a voice service provided by an embodiment of the present disclosure;

FIG. 12 is a schematic flowchart of a network fallback when an MT UE performs a voice service provided by an embodiment of the present disclosure;

FIG. 13 is a schematic diagram of a composition of a network apparatus provided by an embodiment of the present disclosure;

FIG. 14 is a schematic diagram of a specific hardware structure of a network apparatus provided by an embodiment of the present disclosure;

FIG. 15 is a schematic diagram of a composition of another network apparatus provided by an embodiment of the present disclosure;

FIG. 16 is a schematic diagram of a specific hardware structure of another network apparatus provided by an embodiment of the present disclosure;

FIG. 17 is a schematic diagram of a composition of still another network apparatus provided by an embodiment of the present disclosure; and

FIG. 18 is a schematic diagram of a specific hardware structure of still another network apparatus provided by an embodiment of the present disclosure.

### DESCRIPTION OF EMBODIMENTS

In order to have a more detailed understanding of the features and technical contents of the embodiments of the present disclosure, the following is a detailed description of the implementation of the embodiments of the present disclosure in combination with the accompanying drawings. The accompanying drawings is used for reference only, rather than for defining the embodiments of the present disclosure.

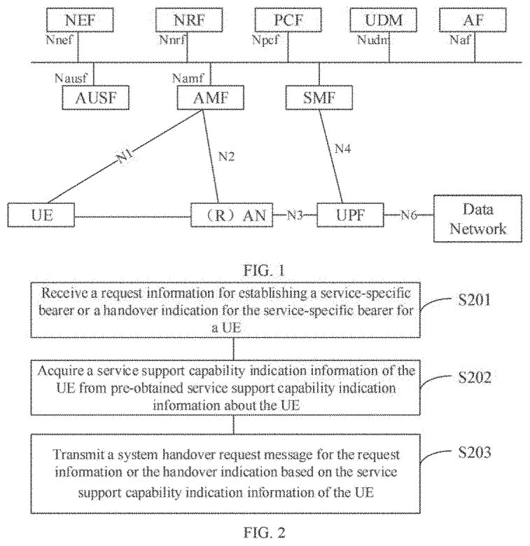

Referring to FIG. 1, an atypical 5G network infrastructure, referred to as a Service-Based Architecture (SBA), is shown. As shown in FIG. 1, a User Equipment (UE) is accessed to a Core Access and mobility Management Function (AMF) through a (Radio) Access Network ((R) AN), and the User Equipment (UE) may also be directly accessed to the AMF; the AMF is configured to process a control plane message of a network, and has a function similar to an Evolved Packet System (EPS) Mobility Management (EMM) in a Mobility Management Entity (MME) in a Long Term Evolution (LTE) system. An Authentication Service Function (AUSF) is similar to a health feature of the MME in the LTE system, implements a bidirectional authentication for the UE, and supports a unified authentication framework. A User plane Function (UPF) is similar to an integration of a server gateway S-GW and a Public Data Network (PDN) gateway (P-GW) in the LTE system, and is connected to a Data Network. A Session Management Function (SMF) is similar to an EPS session Management (ESM) Function in the LTE system, and mainly manages, establishes, modifies and releases a session. It can be seen that a functional set of AUSF, AMF and SMF is similar to the MME in the LTE system. In addition, the structure shown in FIG. 1 further includes: a Network Exposure Function (NEF), a Network Element (NE) Repository Function (NRF), a Policy Control Function (PCF), a Unified Data Management (UDM), and an Application Function (AF); where, the NEF is configured to externally expose some capabilities of the network functions, such as a monitoring capability, a supply capability, and a policy or charging capability; NRF can support a service discovery function; the PCF supports a unified policy framework that manages a network behavior; the UDM includes an application Front End (FE) and a User Data Repository (UDR), the FE can access subscription user information in the UDR, the function of the UDM is similar to that of an Home Subscriber Server (HSS) in the LTE system, the UDR provides a subscription data storage service, and the application Front End FE provides a data-based application logic: and the AF is configured to provide an application service.

Based on the above architecture, it should be noted that, in a 5G network, a terminal needs to register to the 5G network through a registration procedure to perform a 5G service. The registration procedure of 5G is different from an attachment procedure of a Long Term Evolution (LTE) system, which does not include a session establishment procedure, and after the registration of the terminal is completed, the AMF transmits information related to the session, for example. Non Stand Alone (NSA) information to the SMF through an N11-Request message of an N11 interface, and then the SMF determines whether to trigger the session establishment procedure.

The technical solutions of the embodiments of the present disclosure may be applied in the above-mentioned atypical 5G network infrastructure, and therefore, based on the above-mentioned structure, the following embodiments are proposed:

### Embodiment 1

Referring to FIG. 2, which shows a method for a service bearer network handover according to an embodiment of the present disclosure, where the method may be applied to a Session Management Function (SMF) in a 5G network architecture, and the method includes:
S201: receive a request information for establishing a service-specific bearer or a handover indication for the service-specific bearer for a UE;
it should be noted that the handover indication for the service-specific bearer is used to indicate a service of which the service-specific bearer needs a handover from 5G to 4G or 2G/3G, or to indicate a handover of a whole service system from 5G to 4G or 2G/3G;
S202: acquire a service support capability indication information of the UE from pre-obtained service support capability indication information about the UE; and
S203: transmit a system handover request message for the request information or the handover indication based on the service support capability indication information of the UE.

Specifically, a Voice over Internet Protocol (VoIP) service is borne in an LTE network architecture, while a circuit switched service is borne in a 2G or 3G network, and when a UE performs a voice service, a network type home by the service needs to be determined. Therefore, first, a service support capability of the UE needs to be known, and therefore, taking the voice service as an example, the service support capability indication information of the UE may include: indication information used to indicate that the UE needs a voice service and only supports a VoIP service, indication information used to indicate that the UE needs the voice service and only supports a circuit switched service, indication information used to indicate that the UE needs the voice service and supports the Voice over Internet Protocol VoIP service and the circuit switched service, or indication information used to indicate that the UE does not need the voice service, or indication information used to indicate a network bearing an emergency call service.

Specifically, the above five types of the service support capability indication information of the UE may be represented by setting a specific parameter value. For example: when the parameter value is set to be “0”, it means that the UE needs the voice service and supports only an VoIP phone (including Voice over New Radio (VoNR). Voice over Long Term Evolution (VoLTE). Voice over Wireless Fidelity (VoWiFi), Voice over Evolved Universal Mobile Telecommunications System (UMTS) Terrestrial Radio Access (VoE-UTRA), or the like); when the parameter value is set to be “1”, it means that the UE needs the voice service and only supports a circuit switched voice (including CSFB and 3G Circuit Switched (CS) domain calls); when the parameter value is set to be “2”, it means that the UE needs the voice service and supports VoIP and circuit switched voices at the same time; when it is set to be “3”, it means that the UE does not need the voice service: the indication information used to indicate the network bearing the emergency call service may be used to indicate that the network bearing the emergency call service is a 5G network or a 4G network or an 2G/3G network, and therefore, when the parameter value is set to be “4”, it means that the emergency call service for the UE is borne through the 5G network; when the parameter value is set to be “5”, it means that the emergency call service for the UE is borne through the 4G network; and when the parameter value is set to be “6”, it means that the emergency call service for the UE is borne through the 2G/3G network.

For the five types of service support capability indication information of the UE, it can be known that, when the UE needs to perform the voice service, a target network type falling back from a 5G network can be determined according to the service support capability indication information of the UE, for example, falling back from the 5G network to the 4G network; or from the 5G network to the 2G or 3G; either the emergency call is borne through the 4G network or the emergency call is borne through the 2G/3G network. The network side can actively judge whether to trigger a fallback to the 2G or 3G or 4G of the UE, so that the voice service of the UE can be normal established in case the 5G network is guaranteed.

It should be noted that, the embodiment of the present disclosure take the voice service as an atypical example to illustrate the technical solution of the embodiment, and it can be understood that the person skilled in the art can apply the technical solution of the embodiment of the present disclosure to other services under a guidance of the voice service example, and details of the embodiment of the present disclosure are not repeated herein again.

For various target network types, the transmitting a system handover request message for the request information or the handover indication based on the service support capability indication information of the UE includes:
when the service support capability indication information of the UE indicates that the UE supports the VoIP service or the indication information used to indicate the network bearing the emergency call service represents that the emergency call service is borne through a 4G network, transmitting first fallback indication information to a next generation radio access network NG-RAN through a core access and mobility management function (AMF); where the first fallback indication information is used to indicate a handover of the service-specific beater from a 5G network to the 4G network or a handover of the service system from the 5G to the 4G; and
when the service support capability indication information of the UE is used to indicate that the UE only supports the circuit switched service or the indication information used to indicate the network bearing the emergency call service represents that the emergency call service is borne through an 2G/3G network, transmitting a second fallback indication information to the UE through the AMF; where the second fallback indication information is used to indicate a fallback of the service-specific bearer from the 5G network to the 2G or 3G network or a handover of the service system handover from the 5G to the 2G or 3G.

For the technical solution shown in FIG. 2, the pre-obtained service support capability indication information about the UE may be acquired by the SMF during a procedure of registration or session establishment of the UE. Therefore, in a first possible implementation, before the receiving a request information for establishing a service-specific bearer or a handover indication for the service-specific bearer for a user equipment UE, the method further includes:
receive the service support capability indication information of the UE transmitted by an AMF in a registration procedure of the UE.

In some embodiments, the receiving the service support capability indication information of the UE transmitted by an AMF includes:
receive an N11-Request message transmitted by the AMF and carrying the service support capability indication information of the UE; and
analyze the N11-Request message to obtain the service support capability indication information of the UE.

In a second possible implementation, before the receiving a request information for establishing a service-specific bearer or a handover indication for the service-specific bearer for a user equipment UE, the method further includes:
receive the service support capability indication information of the UE transmitted by an AMF and/or a UDM in a session establishment procedure for the UE.

In some embodiments, the receiving the service support capability indication information of the UE transmitted by an AMF and/or a UDM in a session establishment procedure for the UE includes:
receive a session management SM Request message transmitted by the AMF and carrying the service support capability indication information of the UE, and analyze the SM Request message to obtain the service support capability indication information of the UE; and/or
receive a Subscription data response message transmitted by the UDM and carrying the service support capability indication information of the UE, and analyze the Subscription data response message to obtain the service support capability indication information of the UE.

Through the above two possible implementations, taking the voice service as example, the SMF may determine, after acquiring the service support capability indication information of the UE in advance, whether a bearer of a voice service falls back from a 5G network to a 4G network or from the 5G network to a 2G or 3G network according to the service support capability indication information of the UE when the UE performs the voice services, thereby determining whether to transmit a first fallback indication information or a second fallback indication information. Therefore, the UE cannot sense a fallback of a service bearer network in the network side, and the UE also does not need to actively judge a initiating mode of the a voice service, thereby reducing a complexity of customizing and deploying the UE, and the network side may determine whether to trigger the fallback to ensure a successful establishment of a service connection according to a service support capability of the UE in combination with a service support capability of the network side itself.

### Embodiment 2

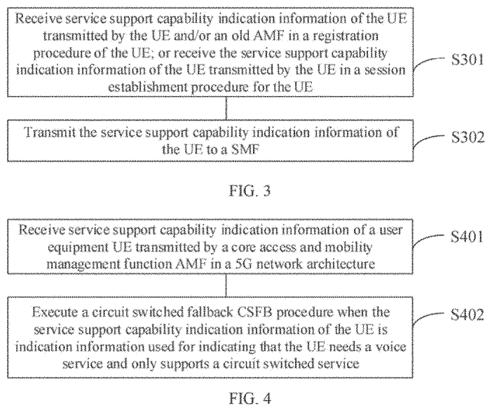

Based on the same technical concept as that of the foregoing embodiment, referring to FIG. 3, which shows a method for a service bearer network handover provided by an embodiment of the present disclosure, where the method is applied to a core access and mobility management function (AMF) in a 5G network architecture, and the method includes:
S301: receive service support capability indication information of a UE transmitted by the UE and/or an old AMF in a registration procedure of the UE; or receive the service support capability indication information of the UE transmuted by the UE in a session establishment procedure for the UE; and
S302: transmit the service support capability indication information of the UE to a session management function SMF;
where the service support capability indication information of the UE is used for the SMF to perform a system handover when a service-specific bearer is established for the UE.

For the technical solution shown in FIG. 3, taking a voice service as an example, the service support capability indication information of the UE includes: indication information used to indicate that the UE needs a voice service and only supports a VoIP service, indication information used to indicate that the UE needs the voice service and only supports a circuit switched service, indication information used to indicate that the UE needs the voice service and supports the Voice over Internet Protocol VoIP service and the circuit switched service, or indication information used to indicate that the UE does not need the voice service, or indication information used to indicate a network bearing an emergency call service.

For the technical solution shown in FIG. 3, in a specific implementation, the receiving service support capability indication information of a user equipment (UE) transmitted by the UE and/or an old AMF in a registration procedure of the UE may include:
receive a Registration Request message transmitted by the UE; where, the service support capability indication information of the UE is borne in the Registration Request message after being encapsulated by Network Attached Storage (NAS);
receive an Information Response message transmitted by the old AMF and bearing the service support capability indication information of the UE.

It can be understood that, when AMF migration or handover occurs, a current AMF in the technical solution shown in FIG. 3 transmits the Information Request message to the old AMF, and at this time, the old AMF will make the previously stored service support capability indication Information of the UE borne in the Information response message and return it to the current AMF.

It should be noted that, since the service support capability indication information of the UE transmitted by the UE is higher in timeliness than the service support capability indication information of the UE transmitted by the old AMF, the service support capability indication information of the UE transmitted by the UE has a higher priority. Based on this, when the service support capability indication information of the UE respectively transmitted by the UE and the old AMF is received, the transmitting the service support capability indication information of the UE to a session management function SMF includes.
transmit the service support capability indication information of the UE transmitted by the UE to the SMF.

For the above specific implementations, in the registration procedure of the UE, the transmitting the service support capability indication information of the UE to a session management function SMF includes:
transmit an N11-Request message carrying the service support capability indication information of the UE to the SMF.

For the technical solution shown in FIG. 3, in a specific implementation, the receiving the service support capability indication information of the UE transmitted by the UE in a session establishment procedure for the UE includes:
receive a Protocol Data Unit PDU Session Establishment Request message transmitted by the UE, where the PDU Session Establishment Request message carries the service support capability indication information of the UE.

For the above specific implementations, in the session establishment procedure for the UE, the transmitting the service support capability indication information of the UE to a session management function SMF includes:
transmit a session management SM Request message carrying the service support capability indication information of the UE to the SMF.

Through the above specific implementations, it can be known that the SMF may perform a system handover when establishing a service-specific bearer for the UE according to the received service support capability indication information of the UE, and the procedure for the SMF to specifically determine the system handover may refer to the description in Embodiment 1, which is not repeated herein again, but for the AMP, after transmitting the service support capability indication information of the UE to the SMF, the method further includes:
receive a first fallback indication information transmitted by the SMF, and transmitting the first fallback indication information to a next generation radio access network NG-RAN; where the first fallback indication information is used to indicate a fall back of the service-specific bearer from a 5G network to a 4G network or a handover of a service system from 5G to 4G;
or receive a second fallback indication information transmitted by the SMF, and transmitting the second fallback indication information to the UE; where the second fallback indication information is used to indicate a fallback of the service-specific bearer from the 5G network to a 2G or 3G network or a handover of the service system handover from the 5G to the 2G or 3G.

In addition, in the procedure of performing the system handover, after receiving the first fallback indication information or the second fallback indication information, the method further includes:
transmit the service support capability indication information of the UE to a Mobility Management Entity MME;
where if the first fallback indication information is received, the service support capability indication information of the UE includes: indication information used to indicate that the UE needs a voice service and only supports a VoIP service, or indication information used to indicate that the UE needs the voice service and supports the Voice over Internet Protocol VoIP service and the circuit switched service, or indication information used to indicate a network bearing an emergency call service, which represents that the emergency call service is borne through a 4G network; and
if the second fallback indication information is received, the service support capability indication information of the UE is indication information used to indicate that the UE needs the voice service and only supports a circuit switched service, or indication information used to indicate a network bearing an emergency call service, which represents that the emergency call service is borne through an 2G/3G network.

It can be known that, the MME, after acquiring the service support capability indication information of the UE through the AMF, can perform service hearer after the handover from the 5G network to the 4G network. The procedure of the MME performing the service bearer refers to the Embodiment 3 followed.

### Embodiment 3

Based on the same technical concept as that of the foregoing embodiments, referring to FIG. 4. which shows a method for a service bearer network handover provided by an embodiment of the present disclosure, where the method is applied to a mobility management entity MME in a 4G network architecture, and the method includes:
S401: receive service support capability indication information of a user equipment UE transmitted by a core access and mobility management function (AMF) in a 5G network architecture; and
S402: execute a circuit switched fallback CSFB procedure when the service support capability indication information of the UE is indication information used to indicate that the UE needs a voice service and only supports a circuit switched service.

It should be noted that, in the technical solution shown in FIG. 4, a specific implementation of S401 may include: receive a Relocation Request transmitted by the AMF and carrying the service support capability indication information of the UE in a procedure of a handover from a 5G network to a 4G network.

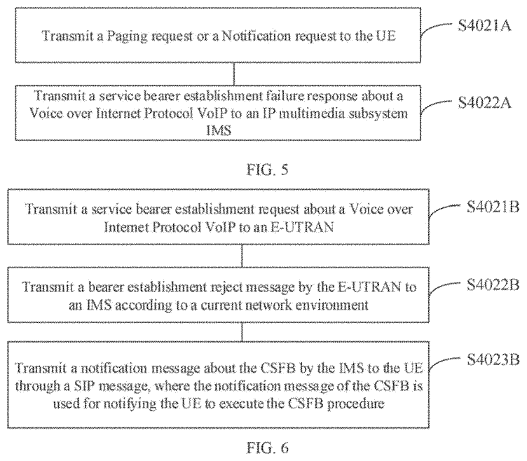

For the technical solution shown in FIG. 4, in a possible implementation, referring to FIG. 5, the executing a CSFB procedure includes:
S4021A: transmit a Paging request or a Notification request to the UE; where the Paging request or the Notification request is used to indicate the UE to execute the CSFB procedure; and
S4022A: transmit a service bearer establishment failure response about a Voice over Internet Protocol VoIP to an IP multimedia subsystem IMS.

It should be noted that, for the above implementations, the CSFB procedure is judged by the MME performing trigger.

For the technical solution shown in FIG. 4, in another possible implementation, referring to FIG. 6. the executing a CSFB procedure includes:
S4021B: transmit a service bearer establishment request about a Voice over Internet Protocol VoIP to an Evolved UMTS Terrestrial Radio Access Network (E-UTRAN);
S4022B: transmit a bearer establishment reject message by the E-UTRAN to an IMS according to a current network environment; and
S4023B: transmit a notification message about the CSFB by the IMS to the UE through a SIP message, where the notification message of the CSFB is used to notify the UE to execute the CSFB procedure.

It should be noted that, for the above implementation, the CSFB procedure is judged by the E-UTRAN performing trigger, it should be noted that, the transmitting a bearer establishment reject message by the E-UTRAN to an IMS according to a current network environment may include.
when the E-UTRAN does not support a VoIP service bearer establishment, transmit the bearer establishment reject message to the IMS; for example, an evolved node B (eNodeB) in the E-UTRAN does not have an associated License installed and thus cannot recognize a bearer establishment request for the Voice over Internet Protocol VoIP service;
or when a network environment of the E-UTRAN cannot meet a network environment required for the VoIP service bearer establishment, transmit the bearer establishment reject message to the IMS; for example, the network of the E-UTRAN is congested, such that it does not meet the network environment required for the VoIP service bearer establishment;
or when the UE is in a range of the E-UTRAN and a signal strength of the UE is lower than a preset strength threshold, transmit the bearer establishment reject message to the IMS; for example, the UE is in a weak coverage range of the E-UTRAN such that the eNodeB cannot establish a VoIP service bearer for the UE.

### Embodiment 4

Based on the same inventive concept as that of the foregoing embodiments, the present embodiment illustrates the technical solutions of the foregoing three embodiments by the following specific examples. In the embodiment, a voice service is used as an atypical example to illustrate the technical solutions, and it can be understood that the person skilled in the art can apply the technical solution of the embodiment of the present disclosure to other services under a guidance of the voice service example, and details of the embodiment of the present disclosure are not repeated herein again.

First, the embodiment explains a procedure of a SMF obtaining service support capability indication information of a UE through a specific example 1 and a specific example 2; next, on the basis of the technical solutions of the specific example 1 and the specific example 2, the present embodiment explains, by a specific example 3. a procedure of a service bearer network handover in a voice service procedure of the UE; finally, the procedure of triggering CSFB after the voice service falls back from a 5G network to a 4G network is explained by a specific example 4.

### Specific Example 1

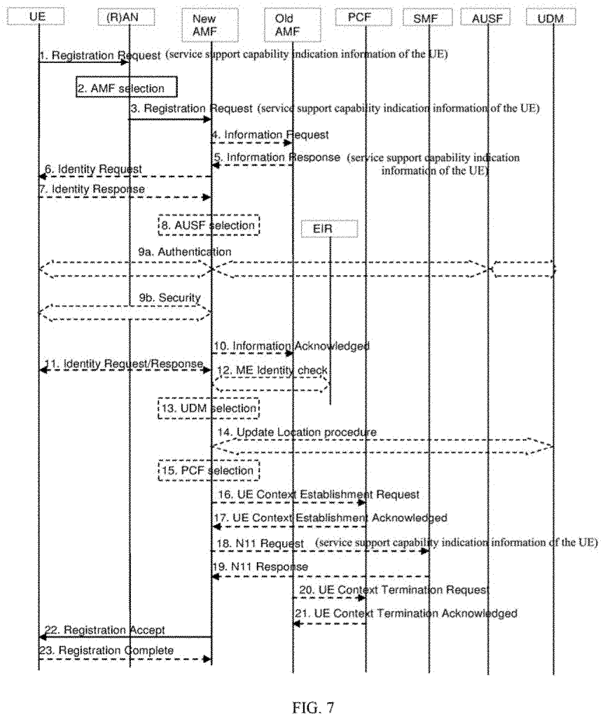

In the specific example, the SMF may obtain the service support capability indication information of the UE during the UE registration procedure, and the specific flow is shown in FIG. 7, and it should be noted that the flow of the technical solution shown in FIG. 7 is the same as a registration flow described in a Clause 4.2.2.2.2 section in the Technical Specification (TS) 23.502 version of the 3rd Generation Partnership Project (3GPP).

Firstly, in a UE registration procedure, the AMF may acquire the service support capability indication information of the UE, and the specific procedure is as follows:
the UE performs a NAS encapsulation on its own service support capability indication information and made it home in Registration Request information; subsequently, the UE transmits the Registration Request message to an (R)AN; then, the (R)AN performs an AMF selection on the AMF, and then transmits the Registration Request message to the selected AMF, which is called new AMF in the specific example; therefore, the above steps realize that the new AMF acquires the service support capability indication information of the UE from the UE;
in addition, the new AMF may also transmit an Information Request to an old AMF, and receive an Information Response bearing the service support capability indication Information of the UE transmitted by the old AMF.

It should be noted that, since old service support capability indication information of the UE stored in the old AMF may be used as an alternative solution when the new AMF cannot obtain the service support capability indication information from the UE. However, when the new AMF can obtain the service support capability indication information from the UE and also can acquire the service support capability indication information of the UE from the old AMF, the new AMF may consider that the service support capability indication information obtained from Ute UE has a higher priority, so as to ignore the service support capability indication information of the UE acquired from the old AMF.

The above procedure describes a specific procedure in which the AMF acquires the service support capability indication information of the UK, and it can be understood that the above procedure corresponds to steps 1 to 5 in FIG. 7.

In addition, in the UE registration procedure, the new AMF transmits an Identity Request to the UE, and after receiving an Identity Response transmitted by the UE, the new AMF sequentially performs AUSF selection. UDM selection and PCF selection, and performs corresponding authentication, Update step and corresponding information request when each selection is completed. The specific steps are as steps 6 to 17 in FIG. 7, and it should be noted that specific meanings and implementations of steps 6 to 17 may refer to corresponding contents in 3GPP TS 23.502 clause 4.2.2.2.2, which is not repeated herein again.

After the above steps are executed, the new AMF may encapsulate the service support capability indication information of the UE in an N11-Request message and transmit the encapsulated service support capability indication information to the SMF, so that the SMF acquires the service support capability indication information of the UE, the procedure corresponds to step 18 in FIG. 7.

The SMF then transmits an N11-Response to the new AMF. as described in step 19. Then, the subsequent steps of the UE registration procedure, such as steps 20 to 23, are completed. It should be noted that the specific meanings and implementations of steps 19 to 23 may refer to corresponding contents in 3GPP TS 23.502 clause 4.2.2.2.2, which is not repeated herein again.

### Specific Example 2

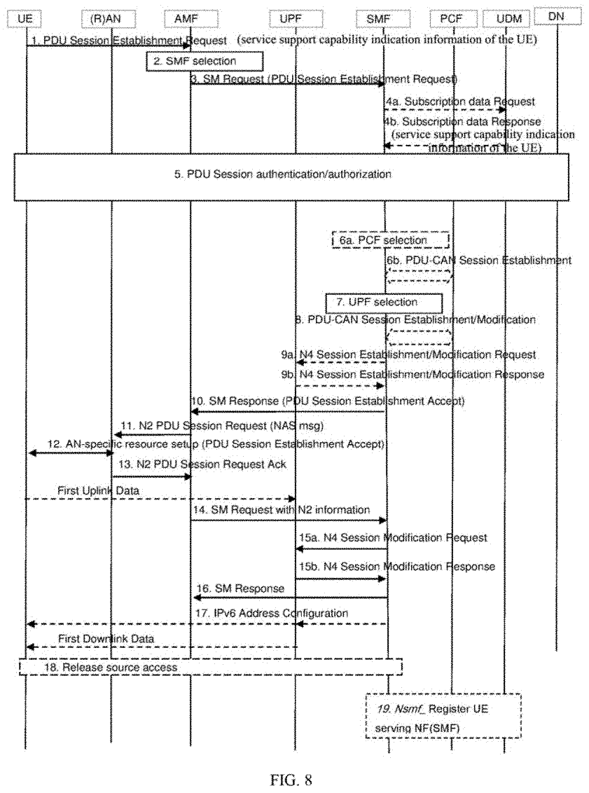

In the specific example, the SMF may obtain the service support capability indication information of the UE during a session establishment procedure of the UE, and the specific flow is as shown in FIG. 8, and it should be noted that the flow of the technical solution shown in FIG. 8 is the same as a session establishment flow described in a clause 4.3.2.2.1 section in the Technical Specification (TS) 23.502 version of the 3rd Generation Partnership Project (3GPP).

Firstly, an AMF obtains the service support ability indication information of the UE from the UE. Specifically, as in step 1, the UE transmits a PDU Session Establishment Request bearing its own service support ability indication information to the AMF; then, after completing a SMF selection according to step 2, the AMF transmits the PDU Session Establishment Request to a selected SMF through a Session Management SM Request, as in step 3; so that the SMF can obtain the service support capability indication information of the UE.

In addition, the SMF may also transmit a Subscription data Request message to a UDM, as in step 4a; subsequently, the UDM encapsulates the service support capability indication information of the UE in a Subscription data response message and transmits it to the SMF, as in step 4b, so that the SMF can obtain the service support capability indication information of the UE as well.

In FIG. 8, the specific meanings and implementations of the subsequent steps 5 to 19 may be refer to corresponding contents in 3GPP TS 23.502 clause 4.3.2.2.1, which is not repealed herein again.

### Specific Example 3

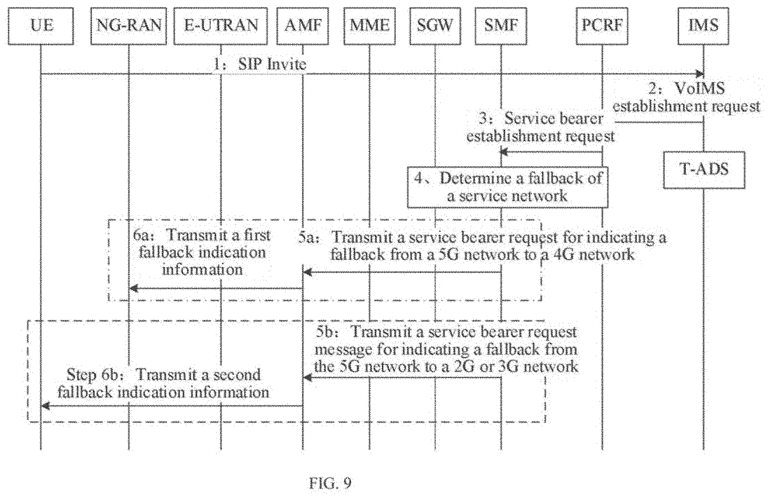

Through the solutions in the above two specific examples, the SMF obtains the service support capability indication information of the UE, so that the SMF may perform a handover for a network bearing a voice service in the voice service procedure of the UE based on the service support capability indication information of the UE. Taking the UE being a Mobile Origination Call (MO) UE as an example, the specific procedure is shown in FIG. 9:
step 1. the MO UE transmits a Session Initiation Protocol (SIP) Invite signaling for establishing a VoIMS (Voice over IMS) to the IMS in a calling procedure;
step 2: the IMS issues a VoIMS establishment request to a Policy and Charging Rules Function (PCRF) for requesting to establish a VoIMS-specific bearer;
step 3: the PCRF transmits a service bearer establishment request to the SMF;
step 4; the SMF determines a fallback of the service network according to the service support capability indication information of the UE;
when the service support capability indication information of the UE is used to indicate that the UE supports the VoIP service, the SMF determines to trigger a fallback from the 5G network to the 4G network, and then, as shown by the dot-dash line box in FIG. 9, step 5a: the SMF transmits a service bearer request for indicating a fallback from the 5G network to the 4G network to the AMF; step 6a: the AMF transmits a first fallback indication information to the NG-RAN; where, the first fallback indication information is used to indicate the fallback of the service-specific bearer from the 5G network to the 4G network or a handover of the service system from the 5G network to the 4G network;
when the service support capability indication information of the UE is used to indicate that the UE only supports the circuit switched service, the SMF determines to trigger a fallback from the 5G network to the 2G or 3G network, and then, as shown by the dashed line box in FIG. 9, step 5b: the SMF transmits a system handover request message for indicating the fallback from the 5G network to the 2G or 3G network to the AMF; step 6b: the AMF transmits a second fallback indication information to the UE: where the second fallback indication information is used to indicate that the fallback of the service-specific bearer from the 5G network to the 2G or 3G network, or a handover of the service system from the 5G network to the 2G or 3G network.

It should be noted that, for a Mobile Termination Call (MT) UE, the difference from the flow shown in FIG. 9 is that: the UE may receive a SIP Invite message in step 1. And consistent with other steps of the MO flow shown in FIG. 9. the IMS issues a VoIMS establishment request to the PCRF. and the SMF determines the fallback of the service network, which is not repeated again in this specific example.

### Specific Example 4

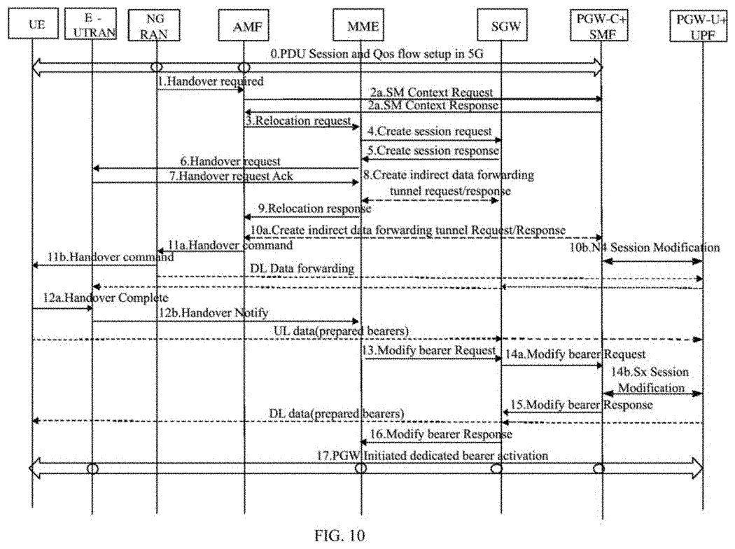

For the Specific Example 3, after the SMF determines the fallback from the 5G network to the 4G network, a flow of a specific handover from the 5G network to the 4G network is shown in FIG. 10, and the handover procedure shown in FIG. 10 is the same as the corresponding contents in the 3GPP TS 23.502, and is not repeated herein again.

It should be noted that in the flow shown in FIG. 10. the AMF may carry, in the Relocation Request message transmitted to the MME in step 3. the service support capability indication information of the UE, so that the MME determines, according lo the service support capability indication information of the UE, whether to bear the voice service of the UE through the VoIP or the CSFB procedure falling back to a circuit switched.

### Specific Example 5

Based on the above Specific Example 3 and Specific Example 4, in this specific example, the MME can determine whether to trigger the CSFB procedure in the VoLTE bearer establishment procedure, and this specific example explains the flow of triggering the CSFB by two aspects in which UE is the MO UE and the MT UE.

### First Aspect

Referring to FIG. 11, which shows a network fallback procedure when the MO UE performs the voice service, the procedure may include:
step 1: the UE transmits a SIP invite message to the IMS: the message is used to request to establish a VoLTE call:

step 2: the IMS issues a VoLTE establishment request to the PCRF, for requesting to establish a VoLTB-specific bearer;

step 3: the PCRF transmits a Bearer establishment request to the SMF and a service or PDN Gateway (S/P-GW, Server/PDN Gateway): the request is used to request an establishment of a VoLTE-specific bearer;

step 4a: after receiving the Bearer establishment request, the SMF determines a fallback of the service network;
after step 4a, the Handover procedure may be executed according to the flow in Specific Example 4. In the handover procedure, the MMF, may acquire service support capability indication information of the UE from the AMF. After the handover procedure is completed, step 4b: the S/P-GW transmits the Bearer establishment request to the MME;
step 5: the MME executes a CSFB procedure according to the service support capability indication information of the UE.

Specifically, when the service support capability indication information of the UE acquired by the MME from the AMF is indication information for indicating that the UE only supports the circuit switched service, it indicates that the MME can acquire that the UE needs the voice service and only supports the circuit switched service, and thus, the CSFB procedure needs to be performed. The CSFB procedure may or may not be triggered by the MME. Thus, when the CSFB procedure is triggered by the MME, referring to the dot-dash line box in FIG. 11, step 6a: transmit a Paging request or a Notification request containing a CSFB indicator to the UE; where the CSFB indicator is used to indicate the UE to execute the CSFB procedure; step 7a: transmit a bearer establishment failure response about the VoLTE service to the IP multimedia subsystem IMS.

It can be understood that, after the UE receives the Paging or Notification request, step 9, the UE can execute the CSFB Procedure according to the CSFB indicator.

When the CSFB procedure is not triggered by the MME, referring to the dashed line box in FIG. 11, step 6b: MME transmits a Bearer setup request about a VoIP service to the E-UTRAN:
step 7b: the E-UTRAN transmits a Bearer establishment reject message to the IMS according to a current network environment.

It can be understood that, for step 7b, in detail, when the eNodeB in the E-UTRAN does not support the specific bearer establishment, e.g. when an associated License is not installed so that the request cannot be recognized, or when the network of the eNodeB is congested so that a network environment required for the VoIP service bearer establishment is not met, or when the UE is in a weak coverage range so that the eNodeB cannot establish a bearer for the UE, the E-UTRAN transmits the Bearer establishment Reject to the IMS.

Step 8b: the IMS transmits an SIP Response message containing the CSFB indicator to UE; as shown in a dot-dash line box, the CSFB indicator is used to indicate the UE to execute the CSFB procedure.

It can be understood that, after the UE receives the SIP Response, step 9: the UE can execute the CSFB Procedure according to the CSFB indicator.

### Second Aspect

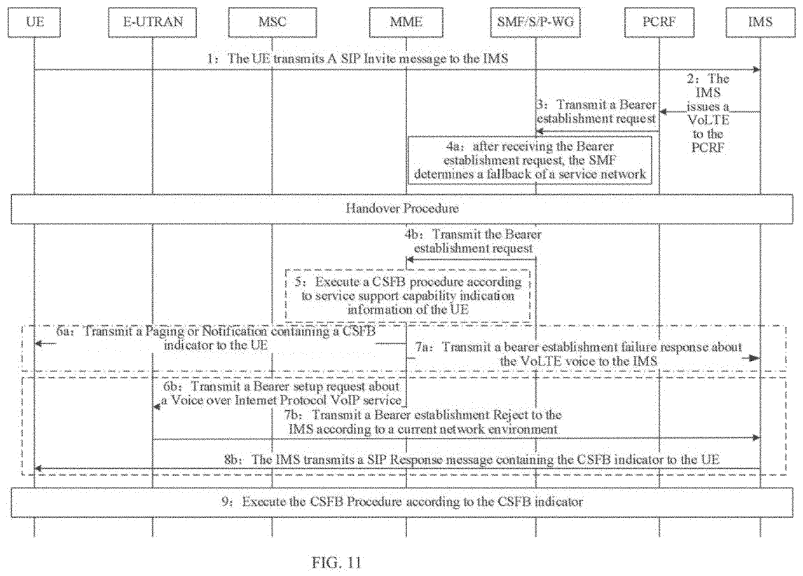

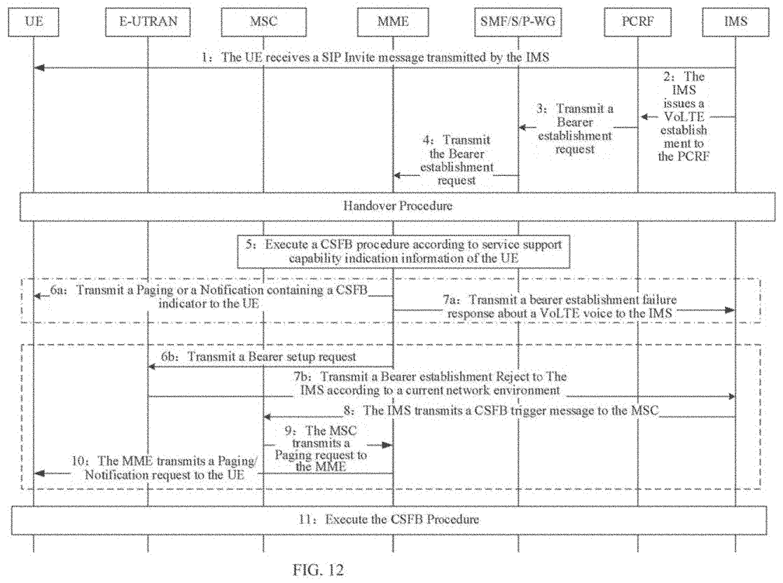

Referring to FIG. 12, which shows a procedure of a network fallback when the MT UE performs the voice service, the procedure may include:
step 1: the UE receives a SIP invite message transmitted by the IMS: the message is used to request to establish a VoLTE call;
step 2: the IMS issues a VoLTE establishment to the PCRF;
step 3; the PCRF transmits a Bearer establishment request to the SMF and the S/P-GW;
step 4: S/P-GW transmits a Bearer establishment request to the MME;
when the SMF receives the bearer establishment request, and after step 4, the handover procedure may be executed according to the flow in Specific Example 4.

Step 5: the MME executes a CSFB procedure according to service support capability indication information of the UE.

Specifically, the CSFB procedure may or may not be triggered by the MME. Thus, when the CSFB procedure is triggered by the MME, referring to the dashed line box in FIG. 12, step 6a: transmit a Paging request or a Notification request containing a CSFB indicator to the UE; step 7a: transmit a bearer establishment failure response about a VoLTE service to the IMS. After the UE receives the Paging or Notification request, step 11: the UE executes the CSFB Procedure.

When the CSFB procedure is not triggered by the MME, referring to the dashed line box in FIG. 12. step 6b: the MME transmits a Bearer setup request to the E-UTRAN.

Step 7b: E-UTRAN transmits a Bearer establishment Reject to IMS according to a current network environment.

It can be understood that the above steps 2 to 7b are the same as the corresponding parts of the first aspect, and are not repeated herein again.

After step 7b, step 8 is further included: the IMS transmits a CSFB trigger message to the Mobile Switching Center (MSC);
step 9: the MSC transmits a Paging request to MME;
step 10: the MME transmits a Paging/Notification request to the UE;
step 11: the UE executes the CSFB Procedure.

The embodiment explains the specific implementations of the technical solutions of the foregoing embodiments through the above specific examples. It can be understood that the above specific examples are merely atypical examples of the specific implementations, and do not limit the technical solutions of the foregoing embodiments.

### Embodiment 5

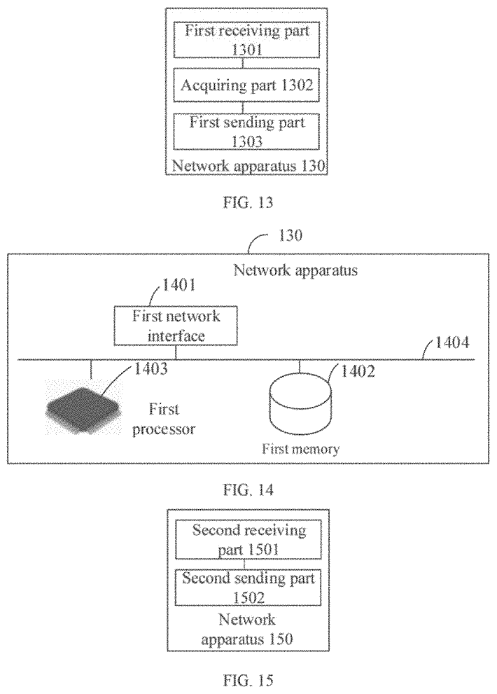

Referring to FIG. 13, which shows a composition of a network apparatus 130 provided by an embodiment of the present disclosure, the network apparatus 130 may implement a function of a SMF in a 5G network architecture, where the network apparatus 130 may include: a first receiving part 1301, an acquiring part 1302, and a first transmitting part 1303; where
the first receiving part 1301 is configured to receive a request information for establishing a service-specific bearer or a handover indication for the service-specific bearer for a user equipment UE; where the handover indication for the service-specific bearer is used to indicate a service of which the service-specific bearer needs a handover from 5G to 4G or 2G/3G, or to indicate a handover of a whole service system from 5G to 4G or 2G/3G;
the acquiring part 1302 is configured to acquire service support capability indication information of the UE from pre-obtained service support capability indication information about the UE; and
the first transmitting part 1303 is configured to transmit a system handover request message for the request information or the handover indication based on the service support capability indication information of the UE.

In a possible implementation, the service support capability indication information of the UE includes: indication information used to indicate that the UE needs a voice service and only supports a VoIP service, indication information used to indicate that the UE needs the voice service and only supports a circuit switched service, indication information used to indicate that the UE needs the voice service and supports the Voice over Internet Protocol VoIP service and the circuit switched service, or indication information used to indicate that the UE does not need the voice service, or indication information used to indicate a network bearing an emergency call service.

In the foregoing implementations, the first transmitting part 1303 is configured to, when the service support capability indication information of the UE indicates that the UE supports the VoIP service or the indication information used to indicate the network bearing the emergency call service represents that the emergency call service is borne through a 4G network, transmit first fallback indication information to a next generation radio access network NG-RAN through a core access and mobility management function AMF; where the first fallback indication information is used to indicate a handover of the service-specific bearer from a 5G network to the 4G network or a handover of the service system from the 5G to the 4G; and
when the service support capability indication information of the UE indicates that the UE only supports the circuit switched service or the indication information used to indicate the network bearing the emergency call service represents that the emergency call service is borne through an 2G/3G network, transmitting a second fallback indication information to the UE through the AMF; where the second fallback indication information is used to indicate a fallback of the service-specific bearer from the 5G network to the 2G or 3G network or a handover of the service system handover from the 5G to the 2G or 3G.

In a possible implementation, the first receiving part 1301 is further configured to receive the service support capability indication information of the UE transmitted by an AMF in a registration procedure of the UE.

In the foregoing implementations, the first receiving part 1301 is configured to receive an N11-Request message transmitted by the AMF and carrying the service support capability indication information of the UE; and
analyze the N11-Request message to obtain the service support capability indication information of the UE.

In a possible implementation manner, the first receiving part 1301 is further configured to receive the service support capability indication information of the UE transmitted by an AMF and/or a Unified Data Management UDM in a session establishment procedure for the UE.

In the foregoing implementations, the first receiving part 1301 is configured to receive a session management SM Request message transmitted by the AMF and carrying the service support capability indication information of the UE, and analyze the SM Request message to obtain the service support capability indication information of the UE; and/or
receive a Subscription data response message transmitted by the UDM and carrying the service support capability indication information of the UE, and analyze the Subscription data response message to obtain the service support capability indication information of the UE.

It can be understood that in the embodiment, “part” may be part of a circuit, part of a processor, part of a program or software, or the like, and may also be a unit, and may also be a modular or may also be non-modularized.

In addition, each component in the embodiment may be integrated in one processing unit, or each unit may exist alone physically, or two or more units are integrated in one unit. The integrated unit can be implemented in a form of hardware or a form of a software functional module.

When the integrated unit is implemented in the form of the software functional module and traded, rather than used as a standalone product, it may be stored in a computer readable storage medium. Based on such understanding, the essence, or the part contributing to prior art, or all or part, of the technical solution of the present embodiment may embody in the form of software product. The computer software product described above is stored in a storage medium and includes instructions for causing a computing device (which may be a personal computer, a server, or a network device, or the like) or a processor to implement some or all of the steps in the methods of the embodiment. The storage medium includes various medium that can store program codes, such as a USB disk, a portable hard disk, a read-only memory (ROM), a random access memory (RAM), a magnetic disk, or an optical disk, or the like.

Accordingly, the embodiment provides a computer readable medium, stores with a program for a service bearer network handover, and the program for the service bearer network handover, when executed by at least one processor, implements the steps of the method according to Embodiment 1.

Based on the network apparatus 130 and the computer readable medium, referring to FIG. 14, which shows a specific hardware structure of the network apparatus 130 provided by the embodiment of the present disclosure, the network apparatus 130 may include: a first network interface 1401, a first memory 1402, and a first processor 1403; the various components are coupled together by a bus system 1404. It can be understood that the bus system 1404 is configured to enable communication connection between these components. The bus system 1404 includes a power bus, a control bus, and a status signal bus in addition to a data bus. The various buses are labeled as the bus system 1404 in FIG. 14 for the sake of clarity of illustration, where the first network interface 1401 is configured to receive and transmit a signal in a process of receiving and transmitting information with other external network elements;
the first memory 1402 is configured to store a computer program capable of running on the first processor 1403; and
the first processor 1403, when running the computer program, is configured to:
receive a request information for establishing a service-specific bearer or a handover indication for the service-specific bearer for a user equipment UE; where the handover indication for the service-specific bearer is used to indicate a service of which the service-specific bearer needs a handover from 5G to 4G or 2G/3G, or to indicate a handover of a whole service system from 5G to 40 or 2G/3G;
acquire service support capability indication information of the UE from pre-obtained service support capability indication information about the UE; and
transmit a system handover request message for the request information or the handover indication based on the service support capability indication information of the UE.

It can be understood that the first memory 1402 in the embodiment of the present disclosure the memory in the embodiments of the present application may be a volatile memory or a non-volatile memory, or may include both volatile and non-volatile memories. The non-volatile memory may be a read-only memory (ROM), a programmable ROM (PROM), an erasable PROM (EPROM), an electrically EPROM (EEPROM) or a flash memory. The volatile memory can be a random access memory (RAM) that acts as an external cache. By way of example rather than limitation, RAM of many forms are available, such as a static RAM (SRAM), a dynamic RAM (DRAM), a synchronous DRAM (SDRAM), a double data rate SDRAM (DDRSDRAM), an enhanced SDRAM (ESDRAM), a synchlink DRAM (SLDRAM) and a direct rambus RAM (DRRAM) It should be noted that the first memory 1402 of the system and method described herein are intended to include, rather than being limited to these and any other suitable types of memories.

The first processor 1403 may be an integrated circuitry chip capable of processing a signal. In the implementation process, each step of the above method may be accomplished by an integrated logic circuit of hardware in the first processor 1403, or instructions in the form of software. The first processor 1403 may be a general-purpose processor, a digital signal processor (DSP), an application specific integrated circuit (ASIC), a field programmable gate array (FPGA), or other programmable logic devices, discrete gates or transistor logic devices or discrete hardware components, the methods, steps, and logical block diagrams disclosed in the embodiments of the present disclosure can be implemented or executed. The general purpose processor may be a microprocessor, or the processor may also be any conventional processor or the like. The steps of the method disclosed with reference to the embodiments of the present disclosure may be directly embodied as being accomplished by the execution of the hardware decoding processor or by a combination of hardware and software modules in the processor. The software module may be located in a storage medium readily available in the art, such as a random access memory, a flash memory, a read only memory, a programmable read only memory or an electrically erasable programmable memory, a register, or the like. The storage medium is located in the first memory 1402. The first processor 1403 reads information in the first memory 1402 and accomplishes the steps of the above methods in combination with the hardware.

It can be understood that the embodiments described herein may be implemented in hardware, software, firmware, middleware, microcode, or any combination thereof. For a hardware implementation, the processing unit may be implemented within one or more Application Specific Integrated Circuits (ASICs), Digital Signal Processors (DSPs), DSP Devices (DSPDs), Programmable Logic Devices (PLDs), Field-Programmable Gate Arrays (FPGAs), general purpose processors, controllers, micro-controllers, microprocessors, other electronic units configured to execute the functions described in the present application or a combination thereof.

For a software implementation, the techniques described herein may be implemented through modules (e.g., procedures, functions, or the like) that perform the functions described herein. A software code may be stored in a memory and executed through a processor. The memory may be implemented within the processor or external to the processor.

Specifically, when the first processor 1403 in the network apparatus 130 is further configured to run the computer program, the steps of the method described in Embodiment 1 are executed, which is not repeated herein again.

### Embodiment 6

Based on the same inventive concept as that of the foregoing embodiments, referring to FIG. 15, which shows a composition of a network apparatus 150 provided by an embodiment of the present disclosure, the network apparatus 150 is capable of implementing a function of a AMF in a 5G network architecture, where the network apparatus 150 may include: a second receiving part 1501 and a second transmitting part 1502; where
the second receiving part 1501 is configured to receive service support capability indication information of a UE transmitted by the UE and/or an old AMF in a registration procedure of the UE; or receive the service support capability indication information of the UE transmitted by the UE in a session establishment procedure for the UE; and
configured to transmit the service support capability indication information of the UE to a session management function SMF; where the service support capability indication information of the UE is used for the SMF to perform a system handover when a service-specific bearer is established for the UE.

In the foregoing solution, the service support capability indication information of the UE includes: indication information used to indicate that the UE needs a voice service and only supports a VoIP service, indication information used to indicate that the UE needs the voice service and only supports a circuit switched service, indication information used to indicate that the UE needs the voice service and supports the Voice over Internet Protocol VoIP service and the circuit switched service, or indication information used to indicate that the UE does not need the voice service, or indication information used to indicate a network bearing an emergency call service.

In the foregoing solution, the second transmitting part 1502 is configured to transmit the service support capability indication information of the UE transmitted by the UE to the SMF.

In the foregoing solution, the second receiving part 1501 is configured to receive a Registration Request message transmitted by the UE through a radio access network RAN, where the Registration Request message carries the service support capability indication information of the UE; and/or
receive an Information Response message transmitted by the old AMF, where the Information Response message carries the service support capability indication Information of the UE.

In the foregoing solution, the second transmitting part 1502 is configured to transmit an N11-Request message carrying the service support capability indication information of the UE to the SMF.

In the foregoing solution, the second receiving part 1501 is configured to receive a Protocol Data Unit PDU Session Establishment Request message transmitted by the UE, where the PDU Session Establishment Request message carries the service support capability indication information of the UE.

In the foregoing solution, the second transmitting part 1502 is configured to transmit a session management SM Request message carrying the service support capability indication information of the UE to the SMF.

In the above solution, the second receiving part 1501 is configured to receive a first fallback indication information transmitted by the SMF, and the second transmitting part 1502 is configured to transmit the first fallback indication information to a next generation radio access network NG-RAN; where the first fallback indication information is used to indicate a fall back of the service-specific bearer from a 5G network to a 4G network or a handover of a service system from 5G to 4G;
or, the second receiving part 1501 is configured to receive a second fallback indication information transmitted by the SMF, and the second transmitting part 1502 is configured to transmit the second fallback indication information to the UE, where the second fallback indication information is used to indicate a fallback of the service-specific bearer from the 5G network to a 2G or 3G network or a handover of the service system handover from the 5G to the 2G or 3G.

In the foregoing solution, the second transmitting part 1502 is further configured to transmit the service support capability indication information of the UE to a mobility management entity MME;
where if the first fallback indication information is received, the service support capability indication information of the UE includes: indication information used to indicate that the UE needs a voice service and only supports a VoIP service, or indication information used to indicate that the UE needs the voice service and supports the Voice over Internet Protocol VoIP service and the circuit switched service, or indication information used to indicate a network bearing an emergency call service, which represents that the emergency call service is borne through a 4G network; and
if the second fallback indication information is received, the service support capability indication information of the UE is indication information used to indicate that the UE needs the voice service and only supports a circuit switched service, or indication information used to indicate a network bearing an emergency call service, which represents that the emergency call service is borne through an 2G/3G network.

Accordingly, the embodiment provides a computer readable medium, stores with a program for a service bearer network handover, and the program for the service bearer network handover, when executed by at least one processor, implements the steps of the method according to Embodiment 2. For the specific description of the computer readable medium, reference is made to the description in Embodiment 5, and it is not repeated herein again.

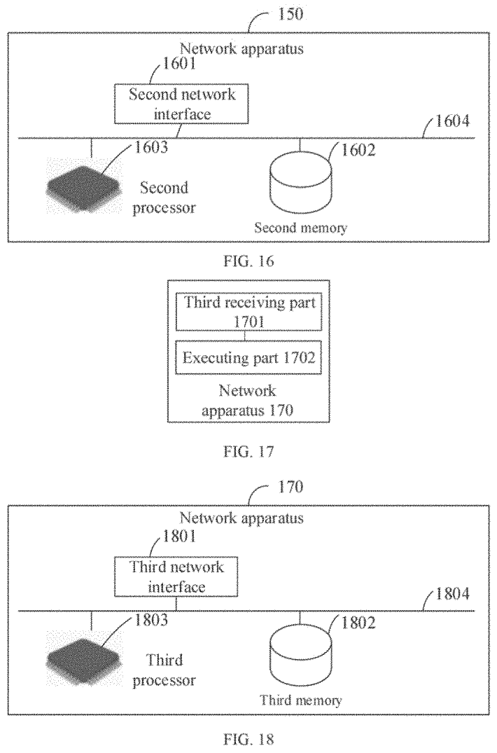

Based on the above-mentioned composition of the network apparatus 150 and the computer readable medium, referring to FIG. 16, a specific hardware structure of the network apparatus 150 provided by the embodiment of the present disclosure is shown, the network apparatus 150 may include:
a second network interface 1601, a second memory 1602, and a second processor 1603; the various components are coupled together by a bus system 1604. It can be understood that the bus system 1604 is configured to enable communication connection between these components. The bus system 1604 includes a power bus, a control bits, and a status signal bus in addition to a data bus. The various buses are labeled as the bus system 1604 in FIG. 16 for the sake of clarity of illustration, where
the second network interface 1601 is configured to receive and transmit a signal in a process of receiving and transmitting information with other external network elements;
the second memory 1602 is configured to store a computer program capable of running on the second processor 1603; and
the second processor 1603, when running the computer program, is configured to:
receive service support capability indication information of a UE transmitted by the UE and/or an old AMP in a registration procedure of the UE; or receive the service support capability indication information of the UE transmitted by the UE in a session establishment procedure for the UE; and
transmit the service support capability indication information of the UE to a session management function SMF; where the service support capability indication information of the UE is used for the SMF to perform a system handover when a service-specific bearer is established for the UE.

It can be understood that, in the embodiment, the components in the specific hardware structure of the network apparatus 150 are similar to the corresponding components in Embodiment 5, and are not repeated herein again.

Specifically, the second processor 1603 in the network apparatus 150 is further configured to execute the steps of the method described in Embodiment 2 when running the computer program, which is not repeated herein again.

### Embodiment 7

Based on the same inventive concept as that of the foregoing embodiments, referring to FIG. 17, which shows a composition of a network apparatus 170 provided by an embodiment of the present disclosure, the network apparatus 170 may include: a third receiving part 1701, an executing part 1702: where
the third receiving part 1701 is configured to receive service support capability indication information of a user equipment UE transmitted by a core access and mobility management function (AMF) in a 5G network architecture; and
the execution part 1702 is configured to execute a circuit switched fallback CSFB procedure when the service support capability indication information of the UE is indication information used to indicate that the UE needs a voice service and only supports a circuit switched service.

In the foregoing solution, the executing part 1702 is configured to transmit a Paging request or a Notification request to the UE; where the Paging request or the Notification request is used to indicate the UE to execute the CSFB procedure; and
transmitting a service bearer establishment failure response about a Voice over Internet Protocol VoIP to an IP multimedia subsystem IMS.

In the above solution, the executing part 1702 is configured to transmit a service bearer establishment request about a Voice over Internet Protocol VoIP to an Evolved UMTS Terrestrial Radio Access Network E-UTRAN; where alter the service bearer establishment request is used for the E-UTRAN to transmit a service bearer establishment reject message to an IMS according to a current network environment, the IMS transmits a notification message about the CSFB to the UE through a SIP message, where the notification message of CSFB is used to notify the UE to execute the CSFB procedure.

In addition, the embodiment provides a computer readable medium, stores with a program for a service bearer network handover, and the program for the service bearer network handover, when executed by at least one processor, implements the steps of the method according to Embodiment 3. For the specific description of the computer readable medium, reference is made to the description in Embodiment 5, and it is not repeated herein again.

Based on the above network apparatus 170 and the computer readable medium, referring to FIG. 18, which shows a specific hardware structure of the network apparatus 170 provided by an embodiment of the present disclosure, the network apparatus 170 may include:
a third network interface 1801, a third memory 1802. and a third processor 1803; the various components are coupled together by a bus system 1804. It can be understood that the bus system 1804 is configured to enable communication connection between these components. The bus system 1804 includes a power bus, a control bus, and a status signal bus in addition to a data bus. The various buses are labeled as the bus system 1804 in FIG. 18 for the sake of clarity of illustration, where
the third network interface 1801 is configured to receive and transmit a signal in a process of receiving and transmitting information with other external network elements;
the third memory 1802 is configured to store a computer program capable of running on the third processor 1803; and
the third processor 1803, when running the computer program, is configured to;
receive service support capability indication information of a user equipment UE transmitted by a core access and mobility management function (AMF) in a 5G network architecture; and
execute a circuit switched fallback CSFB procedure when the service support capability indication information of the UE is indication information used to indicate that the UE needs a voice service and only supports a circuit switched service.

It can be understood that, in the embodiment, the components in the specific hardware structure of the network apparatus 170 are similar to the corresponding components in Embodiment 5, and are not repeated herein again.

Specifically, the third processor 1803 in the network apparatus 170 is further configured to execute the steps of the method described in Embodiment 3 when running the computer program, which is not repeated herein again.

The person skilled in the art should understand that the embodiments of the present disclosure may be provided as a method, system, or computer program product. Accordingly, the present disclosure may take the form of a hardware embodiment, a software embodiment, or an embodiment combining software and hardware aspects. Furthermore, the present disclosure may take the form of a computer program product executed on one or more computer-usable storage media (including, but not limited to, a magnetic disk storage, an optical storage, or the like) having computer-usable program code therein.

The present disclosure is described with reference to flowcharts and/or block diagrams of methods, devices (systems), and computer program products according to the embodiments of the present disclosure. It should be understood that each flow and/or block of the flowcharts and or block diagrams, and combinations of the flow and/or block in the flowcharts and/or block diagrams, can be implemented by computer program instructions. These computer program instructions may be provided to a processor of a general purpose computer, a special purpose computer, an embedded processor, or other programmable data processing apparatus to produce a machine, such that the instructions executed via the processor of the computer or other programmable data processing apparatuses create an apparatus for implementing the functions specified in the one or more flows in the flowchart and/or one or more blocks in the block diagram.

These computer program instructions may also be stored in a computer readable memory capable of guiding a computer or other programmable data processing apparatuses to work in a specific way, so that the instructions stored in the computer readable memory generate a manufacturing article including an instruction apparatus, and the instruction apparatus implements the functions specified in the one or more flows in the flowchart and or one or more blocks in the block diagram.

These computer program instructions may also be loaded onto a computer or other programmable data processing apparatuses to cause a series of operational steps are executed on the computer or oilier programmable apparatuses to produce a computer implemented process, such that the instructions executed on the computer or other programmable apparatuses provide steps for implementing the functions specified in the one or more flows in flowchart and/or one or more blocks in the block diagram.

The above description is only some embodiments of the present disclosure, and is not intended to limit the protection scope of the present disclosure.

### INDUSTRIAL APPLICABILITY

In the embodiments of the present disclosure, the SMF may determine, after acquiring the service support capability indication information of the UE in advance, whether a bearer of a voice service falls back from a 5G network to a 4G network or from the 5G network to a 2G or 3G network according to the service support capability indication information of the UE when the UE performs the voice services, thereby determining whether to transmit a first fallback indication information or a second fallback indication information. Therefore, the UE cannot sense a fallback of a service bearer network in the network side, and the UE also does not need to actively judge a initiating mode of the a voice service, thereby reducing a complexity of customizing and deploying the UE, and the network side may determine whether to trigger the fallback to ensure a successful establishment of a service connection according to a service support capability of the UE in combination with a service support capability of the network side itself.

What is claimed is:

1. A method for a service bearer network handover, which is applied to a network element in a fifth Generation mobile communication technology (5G) network architecture, wherein the method comprises:
receiving a request information for establishing a service-specific bearer or a handover indication for the service-specific bearer for a user equipment (UE); wherein the handover indication for the service-specific bearer is used to indicate a service of which the service-specific bearer needs a handover from 5G to fourth Generation mobile communication technology (4G) or second Generation mobile communication technology (2G/third Generation mobile communication technology (3G). or to indicate a handover of a whole service system from 5G to 4G or 2G/3G:
acquiring service support capability indication information of the UE from pre-obtained service support capability indication information about the UE; and
transmitting a system handover request message for the request information or the handover indication based on the service support capability indication information of the UE.

2. The method according to claim 1, wherein the service support capability indication information of the UE comprises: indication information used to indicate that the UE needs a voice service and only supports a Voice over Evolved Universal Mobile Telecommunications System (UMTS) Terrestrial Radio Access (VoE-UTRA) or Voice over New Radio (VoNR) service, indication information used to indicate that the UE needs the voice service and only supports a circuit switched service, indication information used to indicate that the UE needs the voice service and supports the VoE-UTRA or VoNR service and the circuit switched service, or indication information used to indicate that the UE does not need the voice service, or indication information used to indicate a network bearing an emergency call service.

3. The method according to claim 2, wherein the transmitting a system handover request message for the request information or the handover indication based on the service support capability indication information of the UE comprises:
when the service support capability indication information of the UE indicates that the UE supports the VoE-UTRA service or the indication information used to indicate the network bearing the emergency call service represents that the emergency call service is borne through a 4G network, transmitting first fallback indication information to a next generation radio access network (NG-RAN) through a core access and mobility management function (AMF): wherein the first fallback indication information is used to indicate a handover of the service-specific bearer from a 5G network to the 4G network or a handover of the service system from the 5G to the 4G; and
when the service support capability indication information of the UK indicates that the UE only supports the circuit switched service or the indication information used to indicate the network bearing the emergency call service represents that the emergency call service is borne through an 2G/3G network, transmitting a second fallback indication information to the UE through the AMF: wherein the second fallback indication information is used to indicate a fallback of the service-specific bearer from the 5G network to the 2G or 3G network or a handover of the service system handover from the 5G to the 2G or 3G.

4. The method according to claim 1, wherein before the receiving a request information for establishing a service-specific bearer or a handover indication for the service-specific bearer for a user equipment (UE), the method further comprises: receiving the service support capability indication information of the UE transmitted by an AMF in a registration procedure of the UE.

5. The method according to claim 4, wherein the receiving the service support capability indication information of the UE transmitted by an AMF comprises:
receiving an N11-Request message transmitted by the AMF and carrying the service support capability indication information of the UE; and
analyzing the N11-Request message to obtain the service support capability indication information of the UE.

6. The method according to claim 1, wherein before the receiving a request information for establishing a service-specific bearer or a handover indication for live service-specific bearer for a user equipment (UE), the method further comprises:
receiving the service support capability indication information of the UE transmitted by at least one of an AMF and a Unified Data Management (UDM) in a session establishment procedure for the UE;
wherein the receiving the service support capability indication information of the UE transmitted by at least one of an AMF and an UDM comprises at least one of:
receiving a session management (SM) Request message transmitted by the AMF and carrying the service support capability indication information of the UE, and analyzing the SM Request message to obtain the service support capability indication information of the UE; and
receiving a Subscription data response message transmitted by the UDM and carrying the service support capability indication information of the UE, and analyzing the Subscription data response message to obtain the service support capability indication information of the UE.

7. A network apparatus, comprising: a first network interface, a first memory and a first processor: wherein
the first network interface is configured to receive and transmit a signal in a process of receiving and transmitting information with other external network elements:
the first memory is configured to store a computer program capable of running on the first processor; and
the first processor, when running the computer program, is configured to:
control the first network interface to receive a request information for establishing a service-specific beater or a handover indication for the service-specific bearer for a user equipment (UE): wherein the handover indication for the service-specific bearer is used to indicate a service of which the service-specific bearer needs a handover from fifth Generation mobile communication technology (5G) to fourth Generation mobile communication technology (4G) or second Generation mobile communication technology (2G)/third Generation mobile communication technology (3G), or to indicate a handover of a whole service system from 5G to 4G or 2G/3G;
acquire service support capability indication information of the UE from pre-obtained service support capability indication information about the UE; and
control the first network interface to transmit a system handover request message for the request information or the handover indication based on the service support capability indication information of the UE.

8. The network apparatus according to claim 7, wherein the service support capability indication information of the UE comprises: indication information used to indicate that the UE needs a voice service and only supports a Voice over Evolved Universal Mobile Telecommunications System (UMTS) Terrestrial Radio Access (VoE-UTRA) or Voice over New Radio (VoNR) service, indication information used to indicate that the UE needs the voice service and only supports a circuit switched service, indication information used to indicate that the UE needs the voice service and supports the VoE-UTRA or VoNR service and the circuit switched service, or indication information used to indicate that the UE docs not need the voice service, or indication information used to indicate a network bearing an emergency call service.

9. The network apparatus according to claim 8, wherein the first processor is further configured to:
when the service support capability indication information of the UE indicates that the UE supports the VoE-UTRA service or the indication information used to indicate the network bearing the emergency call service represents that the emergency call service is borne through a 4G network, control the first network interface to transmit first fallback indication information to a next generation radio access network (NG-RAN) through a core access and mobility management function (AMP); wherein the first fallback indication information is used to indicate a handover of the service-specific bearer from a 5G network to the 4G network or a handover of the service system from the 5G to the 4G; and
when the service support capability indication information of the UE indicates that the UE only supports the circuit switched service or the indication information used to indicate the network bearing the emergency call service represents that the emergency call service is borne through an 2G/3G network, control the first network interface to transmit a second fallback indication information to the UE through the AMF; wherein the second fallback indication information is used to indicate a fallback of the service-specific bearer from the 5G network to the 2G or 3G network or a handover of the service system handover from the 5G to the 2G or 3G.

10. The network apparatus according to claim 7, wherein the first processor is further configured to control the first network interlace to receive the service support capability indication information of the UE transmitted by an AMF in a registration procedure of the UE.

11. The network apparatus according to claim 10, wherein the first processor is further configured to:
control the first network interface to receive an N11-Request message transmitted by the AMF and carrying the service support capability indication information of the UE; and
analyze the N11-Request message to obtain the service support capability indication information of the UE.

12. The network apparatus according to claim 7, wherein the first processor is further configured to control the first network interface to receive the service support capability indication information of the UE transmitted by at least one of an AMF and a Unified Data Management (UDM) in a session establishment procedure for the UE;
wherein the first processor is further configured to control the first network interface to perform at least one of:
receiving a session management (SM) Request message transmitted by the AMF and carrying the service support capability indication information of the UE, and analyzing the SM Request message to obtain the service support capability indication information of the UE; and
receiving a Subscription data response message transmitted by the UDM and carrying the service support capability indication information of the UE, and analyzing the Subscription data response message to obtain the service support capability indication information of the UE.

13. A network apparatus, comprising: a second network interface, a second memory and a second processor; wherein
the second network interface is configured to receive and transmit a signal in a process of receiving and transmitting information with other external network elements;
the second memory is configured to store a computer program capable of running on the second processor; and
the second processor, when running the computer program, is configured to:
control the second network interface to receive service support capability indication information of a user equipment (UE) transmitted by at least one of the UE and an old AMF in a registration procedure of the UE; or receive the service support capability indication information of lire UE transmitted by the UE in a session establishment procedure for the UE; and
control the second network interface to transmit the service support capability indication information of the UE to a network element, wherein the service support capability indication information of the UE is used for the network element to perform a system handover when a service-specific beater is established for the UE.

14. The network apparatus according to claim 13, wherein the service support capability indication information of the UE comprises: indication information used to indicate that the UE needs a voice service and only supports a Voice over Evolved Universal Mobile Telecommunications System (UMTS) Terrestrial Radio Access (VoE-UTRA) or Voice over New Radio (VoNR) service, indication information used to indicate that the UE needs the voice service and only supports a circuit switched service, indication information used to indicate that the UE needs the voice service and supports the VoE-UTRA or VoNR service and the circuit switched service, or indication information used to indicate that the UE does not need the voice service, or indication information used to indicate a network bearing an emergency call service.

15. The network apparatus according to claim 13, wherein the second processor is configured to control the second network interface to transmit the service support capability indication information of the UE transmitted by the UE to the network element.

16. The network apparatus according to claim 13, wherein the second processor is further configured to control the second network interface to perform at least one of:
receiving a Registration Request message transmitted by the UE through a radio access network (RAN), wherein the Registration Request message carries the service support capability indication information of the UE; and
receiving an Information Response message transmuted by the old AMF, wherein the Information Response message carries the service support capability indication Information of the UE.

17. The network apparatus according to claim 13, wherein the second processor is further configured to control the second network interface to transmit an N11-Request message carrying the service support capability indication information of the UE to the network element.

18. The network apparatus according to claim 13, wherein the second processor is further configured to control the second network interface to receive a Protocol Data Unit (PDU) Session Establishment Request message transmitted by the UE, wherein the PDU Session Establishment Request message carries the service support capability indication information of the UE.

19. The network apparatus according to claim 13, wherein the second processor is further configured to control the second network interface to transmit a session management (SM) Request message carrying the service support capability indication information of the UE to the network element.

20. The network apparatus according to claim 13, wherein the second processor is further configured to control the second network interface to receive a first fallback indication information transmitted by the network element, and configured to transmit the first fallback indication information to a next generation radio access network (NG-RAN); wherein the first fallback indication information is used to indicate a fall back of the service-specific bearer from a fifth Generation mobile communication technology (5G) network to a fourth Generation mobile communication technology (4G) network or a handover of a service system from 5G to 4G; or the second processor is further configured to control the second network interlace to receive a second fallback indication information transmitted by the network element, and transmit the second fallback indication information to the UE: wherein the second fallback indication information is used to indicate a fallback of the service-specific bearer from the 5G network to a second Generation mobile communication technology (2G) or third Generation mobile communication technology (3G) network or a handover of the service system handover from the 5G to the 2G or 3G;
wherein the second processor is further configured to control the second network interface to transmit the service support capability indication information of the UE to a mobility management entity (MME);
wherein if the first fallback indication information is received, the service support capability indication information of the UE comprises: indication information used to indicate that the UE needs a voice service and only supports a VoE-UTRA or VoNR service, or indication information used to indicate that the UE needs the voice service and supports the VoE-UTRA or VoNR service and the circuit switched service, or indication information used to indicate a network bearing an emergency call service, which represents that the emergency call service is borne through a 4G network, and
if the second fallback indication information is received, the service support capability indication information of the UE is indication information used to indicate that the UE needs the voice service and only supports a circuit switched service, or indication information used to indicate a network bearing an emergency call service, which represents that the emergency call service is borne through an 2G/3G network.
